(19) United States
(12) Patent Application Publication
(10) Pub. No.: US 2026/0212105 A1
(43) Pub. Date: Jul. 23, 2026

(54) LAYOUT PATTERN BASED SEMICONDUCTOR FULL-CHIP SIMULATION METHOD, APPARATUS PERFORMING THE SAME, AND NON-TRANSITORY COMPUTER READABLE MEDIUM STORING COMPUTER PROGRAM PERFORMING THE SAME

(71) Applicant: Samsung Electronics Co., Ltd., Suwon-si (KR)

(72) Inventors: Hyun Jae JANG, Suwon-si (KR); Boo Soo MA, Suwon-si (KR); Sat Byul KIM, Suwon-si (KR); Ji Hye LEE, Suwon-si (KR); Seong Ryeol KIM, Suwon-si (KR); Young-Gu KIM, Suwon-si (KR)

(21) Appl. No.: 19/451,836

(22) Filed: Jan. 16, 2026

(30) Foreign Application Priority Data
Jan. 20, 2025 (KR) 10-2025-0008109

(51) Int. Cl. G06F 30/398; G06F 30/392; G06F 30/394; G06F 119/08; G06F 119/18

(52) U.S. Cl. CPC G06F 30/398; G06F 30/392; G06F 30/394; G06F 2101/10; G06F 2119/08; G06F 2119/18

(57) ABSTRACT

A semiconductor full-ship simulation method may include dividing a full-chip layout of a semiconductor circuit into a plurality of tiles; converting the plurality of tiles into a plurality of image tensors by preprocessing the plurality of tiles; clustering the plurality of tiles by inputting the plurality of image tensors to an artificial intelligence model; determining a representative pattern for each of a plurality of clusters generated as a result of the clustering; substituting each of the plurality of tiles by the representative pattern determined for the cluster to which each of the tiles belongs; extracting properties corresponding to the determined representative pattern by using a representative volume element (RVE) method; mapping the extracted properties to the representative pattern of the full-chip layout; and executing a full-chip simulation of the semiconductor circuit by using the full-chip layout to which the properties are mapped.

### CROSS-REFERENCE TO RELATED APPLICATION

This application claims priority from Korean Patent Application No. 10-2025-0008109 filed on Jan. 20, 2025 in the Korean Intellectual Property Office and all the benefits accruing therefrom under 35 U.S.C. 119, the contents of which in its entirety are herein incorporated by reference.

### BACKGROUND

Analyzing and verifying a layout of an integrated circuit in advance may shorten a development period of the integrated circuit and improve reliability of the integrated circuit. The integrated circuit may be manufactured by a semiconductor process that includes a series of sub-processes. As semiconductors become highly integrated and miniaturized, factors at each stage of designing and manufacturing semiconductor elements act complexly, whereby the layout of the integrated circuit manufactured by the semiconductor process may be formed differently from that designed. Therefore, the semiconductor industry's demand for a simulation environment is increasing to overcome the limitations of the semiconductor process and element, understand a phenomenon and reduce experimental costs. However, there is no full-chip simulation methodology that can consider an effect of a semiconductor layout pattern. Therefore, there is a need for an appropriate approximation method that enables analysis in consideration of a layout pattern and a method capable of speeding up a full-chip simulation by using an artificial intelligence model.

### SUMMARY

The present disclosure relates to a layout pattern-based semiconductor full-chip simulation method, an apparatus performing the same, and a non-transitory computer-readable medium storing a computer program performing the same, and more particularly, to a semiconductor full-chip simulation method that reflects effects of various layout patterns included in a semiconductor circuit and speeds up calculation.

A technical purpose to be achieved through some implementations of the present disclosure is to provide a semiconductor full-chip simulation method, which executes a full-chip simulation of a semiconductor circuit, which reflects an effect of a layout pattern, by determining a representative pattern through clustering of patterns with equivalent properties on a full-chip layout of the semiconductor circuit and extracting properties of the representative pattern.

Another technical purpose to be achieved through some implementations of the present disclosure is to provide a method for speeding up a calculation speed of a semiconductor full-chip simulation by introducing an approximate method and artificial intelligence into a clustering process and a process of extracting properties.

The technical purposes of the present disclosure are not limited to those mentioned above and additional technical purposes of the present disclosure, which are not mentioned herein, will be clearly understood by those skilled in the art from the following description of the present disclosure.

There is provided a semiconductor full-chip simulation method performed by a computing device. The semiconductor full-ship simulation method may comprise: dividing a full-chip layout of a semiconductor circuit into a plurality of tiles; converting the plurality of tiles into a plurality of image tensors by preprocessing the plurality of tiles; clustering the plurality of tiles by inputting the plurality of image tensors to an artificial intelligence model; determining a representative pattern for each of a plurality of clusters generated as a result of the clustering; substituting each of the plurality of tiles by the representative pattern determined for the cluster to which each of the tiles belongs; extracting properties corresponding to the determined representative pattern by using a representative volume element (RVE) method; mapping the extracted properties to the representative pattern of the full-chip layout; and executing a full-chip simulation of the semiconductor circuit by using the full-chip layout to which the properties are mapped.

There is provided a semiconductor full-chip simulation apparatus comprising: a processor; and a memory for storing therein instructions. When the instructions are executed by the processor, the instructions may cause the processor to: divide a full-chip layout of a semiconductor circuit into a plurality of tiles; convert the plurality of tiles into a plurality of image tensors by preprocessing the plurality of tiles; cluster the plurality of tiles by inputting the plurality of image tensors to an artificial intelligence model; determine a representative pattern for each of a plurality of clusters generated as a result of the clustering; substitute each of the plurality of tiles by the representative pattern determined for the cluster to which each of the tiles belongs; extract properties corresponding to the determined representative pattern by using a representative volume element (RVE) method; map the extracted properties to the representative pattern of the full-chip layout; and execute a full-chip simulation of the semiconductor circuit by using the full-chip layout to which the properties are mapped.

There is provided a non-transitory computer readable medium storing therein a computer program. When the computer program is executed by a processor, the processor may be configured to: divide a full-chip layout of a semiconductor circuit into a plurality of tiles; convert the plurality of tiles into a plurality of image tensors by preprocessing the plurality of tiles; cluster the plurality of tiles by inputting the plurality of image tensors to an artificial intelligence model; determine a representative pattern for each of a plurality of clusters generated as a result of the clustering; substitute each of the plurality of tiles by the representative pattern determined for the cluster to which each of the tiles belongs; extract properties corresponding to the determined representative pattern by using a representative volume element (RVE) method; map the extracted properties to the representative pattern of the full-chip layout; and execute a full-chip simulation of the semiconductor circuit by using the full-chip layout to which the properties are mapped.

### BRIEF DESCRIPTION OF THE DRAWINGS

The above and other aspects and features of the present disclosure will become more apparent by describing in detail exemplary implementations thereof with reference to the attached drawings, in which:

FIG. 1 is an exemplary flow chart illustrating a method of designing and manufacturing a semiconductor device according to some implementations of the present disclosure;

FIG. 2 is an exemplary flow chart illustrating a semiconductor full-chip simulation method according to some implementations of the present disclosure in a layout verification step of FIG. 1;

FIG. 3 conceptually illustrates a process of dividing and clustering a full-chip layout into a plurality of tiles and determining a representative pattern in accordance with some implementations of the present disclosure;

FIG. 4 is a flow chart illustrating implementations of the step of determining a representative pattern of FIG. 2;

FIG. 5 conceptually illustrates a process of extracting properties for a representative pattern by using a representative volume element (RVE) method and then mapping the extracted properties to a full-chip layout in accordance with some implementations of the present disclosure;

FIG. 6 is a detailed flow chart illustrating a step of executing a full-chip simulation of FIG. 2;

FIG. 7 is a flow chart illustrating some implementations of a step of determining properties of a mesh of FIG. 6;

FIG. 8 conceptually illustrates a process of determining properties of a mesh in accordance with some implementations of FIG. 7;

FIG. 9 is a flow chart illustrating some other implementations of the step of determining properties of the mesh of FIG. 6;

FIG. 10 conceptually illustrates a process of determining properties of a mesh in accordance with the implementations of FIG. 9; and

FIG. 11 is a block diagram illustrating an exemplary configuration of a semiconductor full-chip simulation apparatus according to some implementations of the present disclosure.

### DETAILED DESCRIPTION

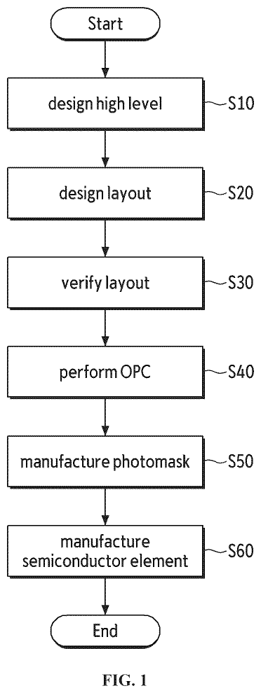

FIG. 1 is an exemplary flow chart illustrating a method of designing and manufacturing a semiconductor device according to some implementations of the present disclosure.

In step S10, a high-level design of the semiconductor device may be performed. The high-level design may mean adopting an idea of a product and describing an integrated circuit based on the adopted idea in a computer language. For example, a semiconductor integrated circuit may be described in a high level language such as C-language. Circuits designed by the high-level design may be expressed in more detail by register transfer level (RTL) coding or simulation. A code generated by register transfer level (RTL) coding may be converted into a netlist and synthesized into an entire semiconductor element. The synthesized schematic circuit may be verified by a simulation tool, and may be accompanied by an adjustment process in accordance with a verification result.

In step S20, a layout design for implementing a logically completed semiconductor integrated circuit on a silicon substrate may be performed. A layout may be configured by arranging layout patterns of various shapes and sizes at positions and in shapes required to constitute a circuit of a semiconductor element. The layout design may mean a procedure of defining a shape or size of a pattern for configuring a transistor and metal wirings to be actually formed on the silicon substrate.

The layout design may be performed based on the schematic circuit synthesized in step S10 or a netlist corresponding thereto. The layout design may include a procedure of placing various standard cells provided from a cell library in accordance with a prescribed design rule and a routing procedure for connecting the standard cells. The cell library may include information on an operation, speed and power consumption of the standard cell.

For example, in order to actually form an inverter circuit on the silicon substrate, a user may search for and select a suitable one among inverters already defined in the cell library. Based on the selected inverter, a P-channel metal-oxide-semiconductor (PMOS), an N-channel metal-oxide-semiconductor (NMOS), an N-WELL, a gate electrode, and circuit patterns, such as metal wirings to be disposed on the PMOS, the NMOS, the N-WELL and the gate electrode, may be properly arranged. Subsequently, routing for the selected and arranged standard cells may be performed. In detail, upper wirings (routing patterns) may be disposed on the arranged standard cells. As routing is performed, the arranged standard cells may be connected to each other in accordance with the design. The arrangement and routing of the standard cells may be automatically performed by an arrangement and routing tool.

In step S30, layout verification may be performed. The layout verification may mean a procedure of checking whether a designed layout conforms to a design rule. The layout verification may include a design rule checking (DRC) process of verifying whether the layout conforms to the design rule, an electronic rule checking (ERC) process of verifying whether the layout is properly done without being electrically disconnected inside, and a layout vs schematic (LVS) process of verifying whether the layout is matched with a gate level netlist.

In particular, the DRC process may predict whether a reproducible integrated circuit may be manufactured by the designed layout. The DRC process may indicate whether the designed layout may be applied to the manufacturing process, or (or additionally) may indicate the possibility of being applied to the manufacturing process with at least one parameter. The DRC process may detect a point, where an error is likely to occur, from the designed layout. A specific point in the layout where the error is likely to occur may be referred to as a ‘hot spot’.

In step S30 according to some implementations of the present disclosure, a semiconductor full-chip simulation may be performed using a full-chip layout of a semiconductor circuit. When a verification (simulation) is performed only with a sampled layout, a hot spot, which is not detected in step S30, may be found in step S60 that is subsequently performed. For example, when step S30 is performed using the sampled layout, a portion of the hot spot may not be detected in step S30 even though the sampled layout may be affected differently by an etch bias depending on the shape or size of the adjacent pattern in step S60. However, when a layout verification (simulation) is performed using the full-chip layout, all hot spots that may occur in the designed layout may be detected in advance in step S30.

In step S40, optical proximity correction (OPC) may be performed. As the optical proximity correction is performed, a distortion phenomenon that may occur when a photolithography process is performed for the layout patterns generated through steps S20 to S30 in a subsequent step may be corrected. That is, as the optical proximity correction is performed, a distortion phenomenon such as a refraction or process effect that occurs due to characteristics of light when a photolithography process is performed in a subsequent step (e.g., S60) may be corrected. As the optical proximity correction is performed, shapes and positions of the designed layout patterns may be slightly changed (biased).

In step S50, a photomask may be manufactured based on the layout biased by the optical proximity correction. The photomask may be manufactured in a manner of describing layout patterns by using a chromium film coated on a glass substrate, but is not limited thereto.

In step S60, a semiconductor element may be manufactured using the photomask. In the process of manufacturing a semiconductor element, various types of exposure processes and etching processes may be repeated. Accordingly, shapes of patterns configured through layout design may be sequentially formed on the silicon substrate.

According to some implementations of the present disclosure, as the layout verification is performed using the full-chip layout in step S30, a pattern defect of the photomask, or a pattern defect of a wafer, which occurs after an exposure process, may be reduced. Also, since the number of revision times of the photomask is reduced, the manufacturing cost of the semiconductor element may be reduced. Hereinafter, step S30 will be described in more detail based on a semiconductor full-chip simulation.

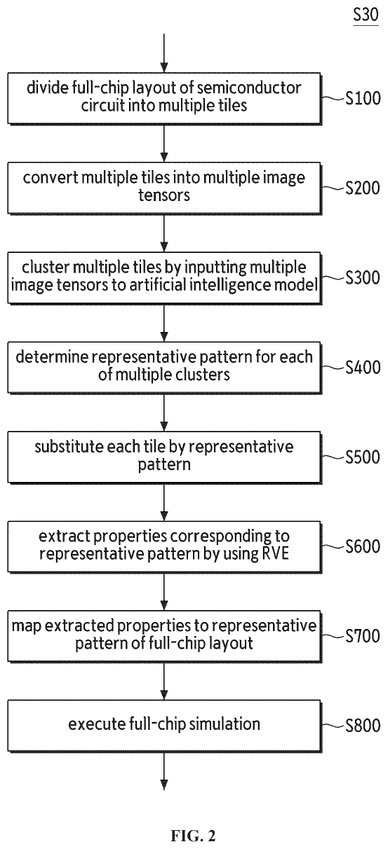

For reference, FIGS. 2 to 10 illustrate steps/operations of a method performed in a semiconductor full-chip simulation apparatus 10 of FIG. 11. Therefore, in the following descriptions, when a subject of a specific step/operation is omitted, it may be understood that the specific step/operation is performed in the semiconductor full-chip simulation apparatus 10 of FIG. 11.

FIG. 2 is an exemplary flow chart illustrating a semiconductor full-chip simulation method according to some implementations of the present disclosure in the layout verification step S30 of FIG. 1. Before the semiconductor full-chip simulation is performed, a full-chip layout of a semiconductor circuit may be acquired from a full-chip layout database.

In step S100, the full-chip layout of the semiconductor circuit may be divided into a plurality of tiles. In step S200, the plurality of tiles may be preprocessed to be converted into a plurality of image tensors. For example, each of the plurality of image tensors may occupy the same unit area on the full-chip layout, and may include geometric design information of the semiconductor circuit. In step S300, the plurality of tensors converted as described above may be input to an artificial intelligence model, and clustering may be performed for the plurality of tiles on the full-chip layout.

In this case, the artificial intelligence model may include an encoder and a decoder. The encoder may refer to a model for compressing, that is, encoding, high-dimensional data x into a low-dimensional latent variable z. The decoder may refer to a model for restoring, that is, decoding, the low-dimensional latent variable z to high-dimensional data x′. When both the encoder and the decoder successfully compress and restore all the given high-dimensional data (x=x′), a latent space of a latent variable may be evaluated as representing high-dimensional data well without loss. In addition, a Euclidean distance in the latent space may be required to be a significant metric.

The artificial intelligence model according to some implementations of the present disclosure may perform clustering for the plurality of tiles by determining whether there is a probability that first and second tiles, which are different from each other among the plurality of tiles on the full-chip layout, belong to the same cluster. For example, the artificial intelligence model according to some implementations of the present disclosure may be trained to minimize a loss function expressed by the following Equation 1.

$${ℒ}_{C} ( X \vert G ) = {\sum }_{i = 1}^{N} \frac{1}{L} {\sum }_{l = 1}^{L} [ log {p}_{θ} ( {x}_{i} \vert {z}_{i}^{( l )} ) - log {q}_{ϕ} ( {z}_{i}^{( l )} \vert {x}_{i} ) + {\sum }_{k = 1}^{K} p ( {c}_{i} = k \vert {z}_{i}^{( l )} ) log {p}_{} ( {z}_{i}^{( l )} \vert {c}_{i} = k ) + {\sum }_{k = 1}^{K} p ( {c}_{i} = k \vert {z}_{i}^{( l )} ) log {π}_{{c}_{i}} - {\sum }_{k = 1}^{K} p ( {c}_{i} = k \vert {z}_{i}^{( l )} ) log {p}_{} ( {c}_{i} = k \vert {z}_{i}^{( l )} ) ] + {\sum }_{i , j = 1 , i \neq j}^{N} {\sum }_{k = 1}^{K} p ( {c}_{i} = k \vert {z}_{i}^{( l )} ) p ( {c}_{j} = k \vert {z}_{i}^{( l )} ) {W}_{i , j} , \qquad [ Equation 1 ]$$

where x may mean high-dimensional data (image tensor converted from tile), z may mean a latent variable, q_{φ} may mean an encoder, and p_{θ} may mean a decoder. π_{ci} represents the prior probability of belonging to cluster cᵢ. The loss function of Equation 1 is based on a pattern shape of tiles xᵢ and xⱼ, a correlation between the tiles xᵢ and xⱼ, and W_{i,j} is a value that varies depending on whether there is a correlation between xᵢ and xⱼ, and may be generally defined as expressed by the following Equation 2.

$${W}_{i , j} \{ \text{} \begin{matrix}> 0 & if there is a mus \text{t-l} ink constraint between {x}_{i} , {x}_{j} \\ = 0 & if no prior information on {x}_{i} , {x}_{j} \\ < 0 & if there is a conno \text{t-li} nk constraint between {x}_{i} , {x}_{j}\end{matrix} \text{} \qquad [ Equation 2 ]$$

That is, it is assumed that xᵢ and xⱼ are image tensors corresponding to two different tiles. In this case, when there is a correlation between tile xᵢ and tile xⱼ, the value of W_{i,j} may be defined as a positive number, and when there is no correlation, the value of W_{i,j} may be defined as a negative number. When there is no information on the correlation between tile xᵢ and tile xⱼ, the value of W_{i,j} may be defined as 0. That is, learning may be performed so that the loss function according to Equation 1 is minimized only when information on the correlation between tile xᵢ and tile xⱼ is clear.

In this case, the existence of the correlation between tile xᵢ and tile xⱼ means that tile xᵢ and tile xⱼ may be clustered in the same cluster. When tile xᵢ and tile xⱼ are clustered in the same cluster, it means that properties corresponding to tile xᵢ and tile xⱼ are similar. Since it is practically impossible to calculate the properties for all the tiles in advance in the full-chip layout, it is practically impossible to directly label the criterion indicating the properties for all the tiles.

Instead, for the learning of the artificial intelligence model for clustering, although it is not the criterion, which directly represents properties, such as density, the criterion that is an important factor in determining properties while reducing the cost of calculation may be used. Similar density of tile xᵢ and tile xⱼ does not mean that the properties of tile xᵢ and tile xⱼ are similar, but when there is a significant difference in density between tile xᵢ and tile xⱼ, it can be concluded that the properties of tile xᵢ and tile xⱼ are also different. Therefore, W_{i,j} may be expressed as Equation 3 below by using density.

$$[ Equation 3 ]$$

$${W}_{i , j} \{ \text{} \begin{matrix}= 0 & \begin{matrix}if \vert Density ( {x}_{i} ) - Density ( {x}_{j} ) \vert < \\ ( Threshold )\end{matrix} \\ \begin{matrix}= Threshold - \\ \vert Density ( {x}_{i} ) - Density ( {x}_{j} ) \vert\end{matrix} & \begin{matrix}if \vert Density ( {x}_{i} ) - Density ( {x}_{j} ) \vert \geq \\ ( Threshold )\end{matrix}\end{matrix} \text{}$$

That is, even though the density difference between tile xᵢ and tile xⱼ is less than a threshold value, it cannot be concluded that there is a correlation between tile xᵢ and tile xⱼ. This observation is the same as the case that information is not given, so that the value of W_{i,j} will be zero (0). However, when the density difference between tile xᵢ and tile xⱼ exceeds the threshold value, it can be concluded that there is no correlation between tile xᵢ and tile xⱼ.

Although not mapped for all the tiles in the full-chip layout, the criterion indicating the properties may be previously labeled for at least some tiles. In this case, the artificial intelligence model may be trained using both the density and the properties previously labeled for some tiles, and W_{i,j} at this time may be expressed as Equation 4 below.

$$[ Equation 3 ]$$

$${W}_{i , j} \{ \text{} \begin{matrix}> 0 & if \vert {RVE}_{( {x}_{i} )} - RVE ( xj ) \vert < \\ & ( {Threshold}_{RVE} ) \\ = {Threshold}_{RVE} - & if \vert {RVE}_{( {x}_{i} )} - RVE ( xj ) \vert \geq \\ \vert {RVE}_{( {x}_{i} )} - RVE ( xj ) \vert + & ( {Threshold}_{RVE} ) \\ δ ( {Threshold}_{RVE} - & \\ \vert Density ( {x}_{i} ) - Density ( {x}_{j} ) \vert ) & \\ = 0 & if no prior information for \\ & RVE on {x}_{i} , {x}_{j} and \\ & \vert Density ( {x}_{i} ) - Density ( {x}_{j} ) \vert < \\ & ( {Threshold}_{DEN} ) \\ = δ ( {Threshold}_{DEN} - & if no prior information for \\ \vert Density ( {x}_{i} ) - Density ( {x}_{j} ) \vert ) & RVE on {x}_{i} , {x}_{j} and \\ & \vert Density ( {x}_{i} ) - Density ( {x}_{j} ) \vert \geq \\ & ( {Threshold}_{DEN} )\end{matrix} \text{}$$

Assuming that RVE(xᵢ) and RVE(xⱼ), which are properties corresponding to tile xᵢ and tile xⱼ, are labeled, it may be considered that the correlation between tile xᵢ and tile xⱼ is definitely present when the difference in properties is less than a threshold value Threshold_{RVE}. On the other hand, when the difference in properties is greater than or equal to the threshold value Threshold_{RVE}, a threshold value Threshold_{Den} for density and a difference in density between tile xᵢ and tile xⱼ may be considered as expressed in Equation 3. On the other hand, assuming that the properties corresponding to tile xᵢ and tile xⱼ are not labeled, the value of W_{i,j} may be determined by considering only the threshold value Threshold_{Den} for density and the difference in density between tile xᵢ and tile xⱼ in the same manner as Equation 3.

Furthermore, in some cases, not only one property but also two or more properties may be previously labeled on some tiles. In this case, a distance (e.g., L1 norm or L2 norm) between the properties may be used, and when there is a priority between the properties, a weighting factor may be additionally introduced.

The AI model trained through the above process will be able to receive an image tensor corresponding to two different tiles and thus output whether the two tiles belong to the same cluster, based on pattern shapes of the two tiles, thereby allowing the tiles on the full-chip layout to be clustered into a plurality of clusters. Additionally, the AI model may be trained to output whether the two tiles belong to the same cluster, by using not only the pattern shapes of the two tiles but also the difference in density between the two tiles, and some of the labeled properties.

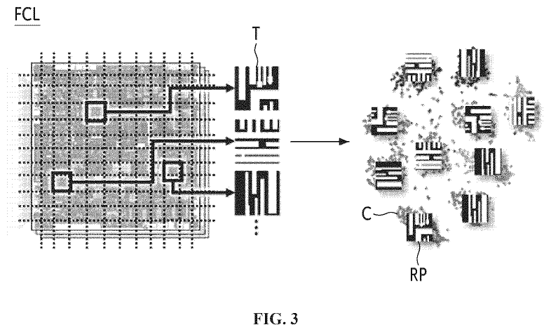

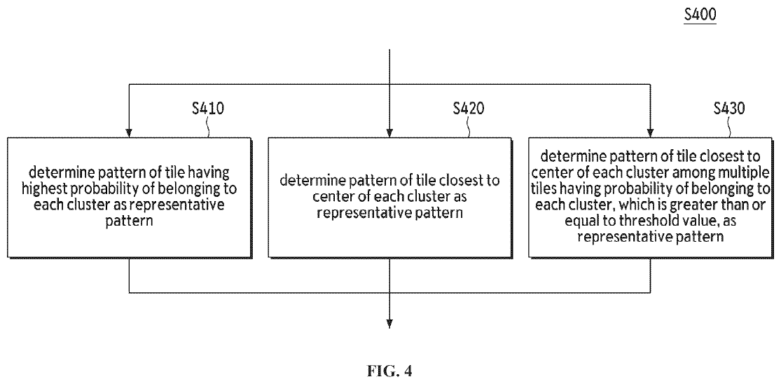

In step S400, a representative pattern may be determined for each of the plurality of clusters generated as a result of clustering. In step S500, each of the plurality of tiles may be substituted by the representative pattern determined for the cluster to which each tile belongs. Hereinafter, step S400 will be described with reference to FIGS. 3 to 4.

FIG. 3 conceptually illustrates a process of dividing and clustering a full-chip layout FCL into a plurality of tiles T and determining a representative pattern RP in accordance with some implementations of the present disclosure. Referring to FIG. 3, the full-chip layout FCL may be divided into the plurality of tiles T through step S100. Each of the plurality of tiles T may represent a different pattern. The plurality of tiles divided as above may be converted into image tensors through the preprocessing of step S200, and may be input to the artificial intelligence model in accordance with step S300. As a result of inputting the image tensor to the artificial intelligence model, the plurality of tiles T may be clustered into a plurality of clusters C. One pattern among patterns represented by the plurality of tiles T included in the cluster C may be determined as the representative pattern RP.

FIG. 4 is a flow chart illustrating implementations of step S400 of determining the representative pattern of FIG. 2. Referring to FIG. 4, in step S410, a pattern of a tile having the highest probability of belonging to each cluster may be determined as a representative pattern of each of the plurality of clusters. Alternatively, in step S420, a pattern of a tile closest to a center of each cluster may be determined as a representative pattern of each of the plurality of clusters. Alternatively, in step S430, a pattern of a tile closest to the center of each cluster among a plurality of tiles having a probability of belonging to each cluster, which is equal to or greater than a preset threshold value, may be determined as a representative pattern of each of the plurality of clusters. That is, the determination of the representative pattern may be performed based on probability, distance, or probability and distance.

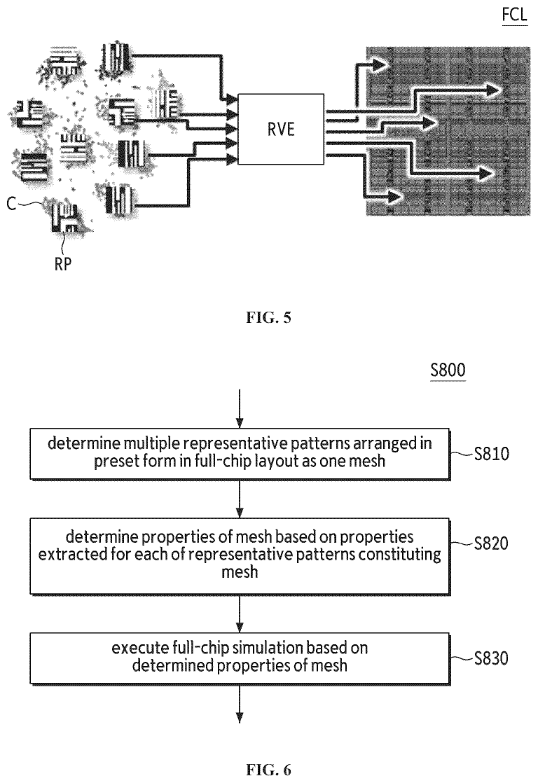

Referring back to FIG. 2, in step S500, each of the plurality of tiles may be substituted by the representative pattern determined for the cluster to which each tile belongs. In step S600, properties corresponding to the representative pattern determined through the representative volume element (RVE) method may be extracted, and in step S700, the extracted properties may be mapped to the representative pattern of the full-chip layout. Hereinafter, steps S500 to S700 will be described with reference to FIG. 5.

FIG. 5 conceptually illustrates a process of extracting properties for a representative pattern by using a representative volume element (RVE) method and then mapping the extracted properties to a full-chip layout in accordance with some implementations of the present disclosure. Referring to FIG. 5, the representative volume element (RVE) method is applied to the representative pattern RP determined in FIG. 3, so that properties for each representative pattern are extracted, and the extracted properties are mapped to a corresponding position of the full-chip layout.

In detail, the plurality of tiles on the full-chip layout may be substituted by a representative pattern of a cluster to which the corresponding tile belongs, and the extracted properties may be mapped with respect to the substituted representative pattern, so that a full-chip layout FCL′ to which the properties are mapped may be generated. The properties extracted using the representative volume element (RVE) method are equivalent properties homogenized for each pattern, and may be used as representative properties for each pattern for a full-chip simulation. Accordingly, the full-chip simulation according to some implementations of the present disclosure may reflect the effect of the layout pattern. The full-chip layout FCL′ mapped as above may be constructed in a simulation structure that may be input to the full-chip simulation.

Referring back to FIG. 2, in step S800, the full-chip simulation of the semiconductor circuit may be executed using the full-chip layout to which the properties are mapped. However, since the full-chip layout to which the properties are mapped still has high resolution in many cases to perform a full-chip scaled computation, it is necessary to adjust the resolution to speed up the calculation. The resolution adjustment may be performed through a process of integrating the substituted representative pattern on the full-chip layout and approximating the properties with respect to the integrated pattern, which will be described later with reference to FIGS. 6 to 10.

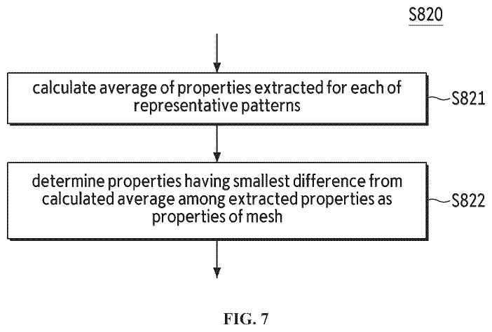

FIG. 6 is a detailed flow chart illustrating a step S800 of executing a full-chip simulation of FIG. 2. Referring to FIG. 6, in step S810, a plurality of representative patterns arranged in a preset form in a full-chip layout may be determined as one mesh. For example, nine representative patterns arranged in three rows and three columns in the full-chip layout may be determined as one mesh. In step S820, properties of the mesh may be determined based on the properties extracted with respect to each of the plurality of representative patterns constituting the mesh. In step S830, the full-chip simulation may be executed based on the determined properties of the mesh. Implementations related to step S820 will be described with reference to FIGS. 7 to 10.

FIG. 7 is a flow chart illustrating some implementations of the step S820 of determining properties of the mesh of FIG. 6. Referring to FIG. 7, in step S821, an average of the properties extracted for each of the plurality of representative patterns may be calculated. In step S822, the properties having the smallest difference from the calculated average among the extracted properties may be determined as the properties of the mesh.

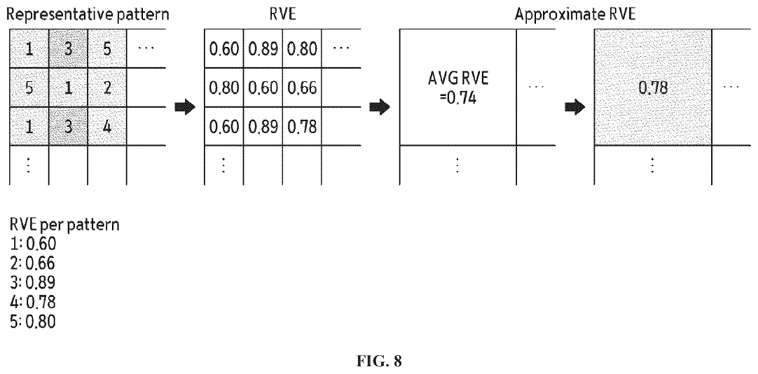

FIG. 8 conceptually illustrates a process of determining properties of a mesh in accordance with the implementations of FIG. 7. Referring to FIG. 8, nine representative patterns arranged in three rows and three columns are determined as one mesh. In the mesh of FIG. 8, nine representative patterns are five types, and properties (RVE values) are determined for each representative pattern. An average of the RVE values for the nine representative patterns is calculated as 0.74, and since an RVE value having the smallest difference from 0.74 is the RVE value (0.78) of the pattern 4, the properties of the mesh may be determined to be approximated to 0.78.

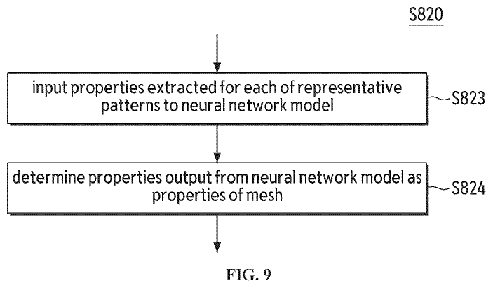

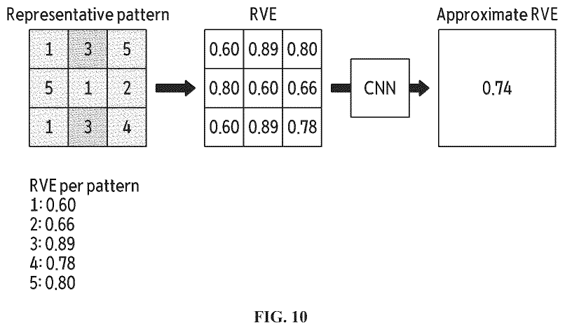

FIG. 9 is a flow chart illustrating other implementations of the step S820 of determining properties of the mesh of FIG. 6. Referring to FIG. 9, in step S823, the properties extracted for each of the plurality of representative patterns may be input to a neural network model. In this case, the neural network model is a model trained to output a single equivalent property (RVE value) by receiving the plurality of representative patterns and the extracted properties (RVE values) and may be a model based on a convolutional neural network (CNN). In step S824, the properties output from the neural network model may be determined as the properties of the mesh.

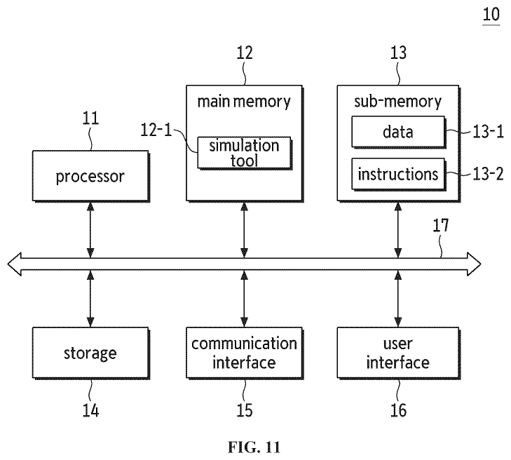

FIG. 10 conceptually illustrates a process of determining properties of a mesh in accordance with the implementations of FIG. 9. Referring to FIG. 10, nine representative patterns arranged in three rows and three columns are determined as one mesh in the same manner as FIG. 8. When a corresponding mesh is input to the neural network model, a single equivalent property (RVE value) of 0.74 is output, and the properties of the mesh may be determined to be approximated to 0.74.

In addition to the method of FIGS. 7 to 10, a calculation speed may be sped up by merging meshes through a dynamic meshing method. For example, in the full-chip layout of the semiconductor circuit, there is a region in which the same pattern is repeated and a region in which various patterns are mixed, and a first mesh and a second mesh, which have a plurality of representative patterns arranged in the same form, may be merged into one mesh.

A type of a full-chip simulation to be executed may vary depending on a type of the properties extracted in accordance with some implementations of the present disclosure. For example, when the properties extracted in step S600 are the properties related to warpage of the semiconductor circuit, a warpage simulation of the semiconductor circuit may be executed in step S800. On the other hand, when the properties extracted in step S600 are the properties related to thermal properties of the semiconductor circuit, a thermal property simulation of the semiconductor circuit may be executed in step S800.

The implementations described above with reference to FIGS. 2 to 10 may be repeated for all layers of the full-chip layout of the semiconductor circuit. The full-chip layout to which properties corresponding to each layer are mapped may be constructed in a simulation structure for a single layer, and the constructed simulation structure may be stacked and used as input data for the full-chip simulation.

FIG. 11 is a block diagram illustrating an exemplary configuration of a semiconductor full-chip simulation apparatus 10 according to some implementations of the present disclosure. In detail, FIG. 11 is a block diagram of an apparatus 10 for performing the semiconductor full-chip simulation method described with reference to FIGS. 2 to 10. Hereinafter, the apparatus 10 will be described with reference to FIGS. 2 to 10, the same reference numerals denote the same elements, and their redundant descriptions will be omitted.

Referring to FIG. 11, the semiconductor full-chip simulation apparatus 10 may include a processor 11, a main memory 12, a sub-memory 13, a storage 14, a communication interface 15, a user interface 16, and a bus 17. The semiconductor full-chip simulation apparatus 10 may be a portion of a semiconductor design system. The semiconductor design system may include various design and verification simulation programs. The semiconductor full-chip simulation apparatus 10 may be implemented as a general-purpose computer or a special-purpose computer for a semiconductor simulation.

The processor 11 may control the semiconductor full-chip simulation apparatus 10 and perform a full-chip simulation for layout verification. The processor 11 may execute software performed in the semiconductor full-chip simulation apparatus 10. The software may include an application program, an operating system, a device driver, and the like. The processor 11 may execute an operating system stored in the main memory 12. The processor 11 may execute various application programs driven based on the operating system. For example, the processor 11 may execute a tool for a simulation by executing instructions 13-2 stored in the sub-memory 13. For example, the processor 11 may execute a simulation tool 12-1 stored in the main memory 12. Accordingly, the processor 11 may perform a series of full-chip simulation steps (S100 to S800 of FIG. 2).

For example, the processor 11 may acquire a full-chip layout of a semiconductor circuit for a simulation by using data 13-1 stored in the sub-memory 13. The processor 11 may perform various simulations for the full-chip layout of the semiconductor circuit by using the simulation tool 12-1 stored in the main memory 12. The processor 11 may cluster a plurality of tiles of the full-chip layout by using an artificial intelligence model stored in the sub-memory 13. The processor 11 may perform the full-chip simulation by determining a representative pattern from the clustering result, extracting properties by using a representative volume element (RVE) method, and mapping the extracted properties to the full-chip layout.

The main memory 12 may be a working memory of the processor 11. The main memory 12 may store the application program, the operating system, the device driver, and the like, which are executed in the processor 11. For example, the main memory 12 may store the simulation tool 12-1. The simulation tool 12-1 may be an application program for the full-chip simulation of the semiconductor circuit. The simulation tool 12-1 may perform warpage simulation or thermal property simulation. The simulation tool 12-1 may be executed through the processor 11.

The main memory 12 may temporarily store data 13-1 or instructions 13-2, which are required by the processor 11, among the data 13-1 and the instructions 13-2, which are stored in the sub-memory 13. The main memory 12 may include at least one of a volatile memory or a nonvolatile memory. For example, the main memory 12 may include at least one of a Read Only Memory (ROM), a Programmable ROM (PROM), an Electrically Programmable ROM (EPROM), an Electrically Erasable and Programmable ROM (EEPROM), a flash memory, a Phase-change RAM (PRAM), a Magnetic RAM (MRAM), a Resistive RAM (RRAM), a Ferroelectric RAM (FRAM), a Dynamic RAM (DRAM), a Static RAM (SRAM), a Synchronous DRAM (SDRAM), a Phase-change RAM (PRAM), a Magnetic RAM (MRAM), a Resistive RAM (RRAM), or a Ferroelectric RAM (FeRAM).

The sub-memory 13 may be a secondary memory of the semiconductor full-chip simulation apparatus 10. The sub-memory 13 may store the data 13-1 and the instructions 13-2. For example, the sub-memory 13 may store a full-chip layout (FCL of FIG. 3), an artificial intelligence model for clustering, and a neural network model for determining properties of a mesh and may store execution instructions of a tool for performing a representative volume element (RVE) method and a full-chip simulation such as a warpage simulation and a thermal property simulation. The full-chip layout (FCL of FIG. 3) may be transferred to the sub-memory 13 through the communication interface 15 or the storage 14 in the form of the data 13-1. A tool for performing the representative volume element (RVE) method and the full-chip simulation may be transferred to the sub-memory 13 through the communication interface 15, which is a modem, or the storage 14, which is detachable, in the form of the instructions 13-2.

The sub-memory 13 may include a memory card (MMC, eMMC, SD, microSD, etc.), a hard disk drive (HDD), a solid state drive (SSD), an optical disk drive (ODD), etc. The sub-memory 13 may include a NAND-type flash memory but is not limited thereto. The sub-memory 13 may include a next generation nonvolatile memory such as PRAM, MRAM, ReRAM and FRAM, or a NOR flash memory.

The storage 14 may include a portable storage that is detachable. For example, the data 13-1 and the instructions 13-2, which are stored in the sub-memory 13, may be transferred from the storage 14 to the sub-memory 13. The storage 14 may be based on one of various standards such as a universal serial bus (USB) and a serial advanced technology attachment (SATA).

The communication interface 15 may perform communication with an external device by wire or wirelessly. For example, the data 13-1 and the instructions 13-2 may be stored in the sub-memory 13 from the external device through the communication interface 15. The data 13-1 and the instructions 13-2, which are stored in the sub-memory 13, may be transferred to the external device through the communication interface 15. The communication interface 15 may be based on the Ethernet.

The user interface 16 may receive an execution command of a tool for a simulation and various commands for simulation functions of the tool from a user. For example, when clustering the plurality of tiles of the full-chip layout through the user interface 16, the user may input a method of determining whether to use an artificial intelligence model trained on a density of the tiles or whether to use an artificial intelligence model trained on the density of the tiles and pre-labeled properties of the tiles, or a method of determining properties of a mesh. The user interface 16 may include various user input interface devices such as a touch sensor, a keyboard, a mouse and a pointing device.

The user interface 16 may transfer a process and a result of the semiconductor full-chip simulation according to the implementations of the present disclosure to the user. The user interface 16 may include various user output interface devices such as a monitor and a printer. The user interface 16 may display the result of performing the semiconductor full-chip simulation through the user output interface device.

The bus 17 may provide a network inside the semiconductor full-chip simulation apparatus 10. The processor 11, the main memory 12, the sub-memory 13, the storage 14, the communication interface 15 and the user interface 16 may be electrically connected to one another through the bus 17 and exchange data with one another.

According to the implementations of the present disclosure, various patterns present in the full-chip layout of the semiconductor circuit are clustered using the artificial intelligence model, the representative pattern is determined for the clusters, equivalent properties are extracted for the representative pattern, and the full-chip simulation is executed using the calculated equivalent properties, so that the full-chip simulation in which the effect of the layout pattern is reflected may be performed and at the same time its calculation speed may be also sped up. In addition, according to the implementations of the present disclosure, various types of full-chip simulations may be executed depending on the types of extracted properties, and the resolution of the mesh may be additionally adjusted before the full-chip simulation is executed, whereby the calculation speed may be optimized, and the practicality of the full-chip simulation may be improved.

Various implementations of the present disclosure and the effects according to those implementations have been mentioned above with reference to FIGS. 1 to 11. The effects are not limited to the effects as mentioned above, and other effects not mentioned may be clearly understood by those skilled in the art from the above descriptions.

All the components that constitute the implementations of the present disclosure are described as being combined with each other or operating in combination with each other. However, the present disclosure is not necessarily limited to these implementations. In other words, within the scope of the purpose of the present disclosure, all of the components may operate in a selective combination manner of at least two thereof with each other.

Although the operations are shown as being executed in a specific order in the drawings, it should not be understood that the operations should be performed in the specific order as shown or in a sequential order or that all illustrated operations should be performed to obtain the desired result.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a combination can in some cases be excised from the combination, and the combination may be directed to a subcombination or variation of a subcombination.

Although implementations of the present disclosure have been described with reference to the accompanying drawings, implementations of the present disclosure are not limited to the above implementations, but may be implemented in various different forms. A person skilled in the art may appreciate that the present disclosure may be practiced in other concrete forms without changing the technical spirit or essential characteristics of the present disclosure. Therefore, it should be appreciated that the implementations as described above is not restrictive but illustrative in all respects.

What is claimed is:

1. A semiconductor full-chip simulation method performed by a computing device, the semiconductor full-chip simulation method comprising:
dividing a full-chip layout of a semiconductor circuit into a plurality of tiles;
converting the plurality of tiles into a plurality of image tensors, wherein converting the plurality of tiles comprises preprocessing the plurality of tiles;
clustering the plurality of tiles, wherein clustering the plurality of tiles comprises inputting the plurality of image tensors to an artificial intelligence model;
obtaining a representative pattern for each cluster of a plurality of clusters generated as a result of the clustering to provide a plurality of representative patterns;
substituting, within each cluster, each tile of the cluster with the representative pattern obtained for the cluster;
extracting, for each representative pattern of the plurality of representative patterns, properties corresponding to the representative pattern to provide extracted properties, wherein extracting the properties comprises using a representative volume element method;
mapping the extracted properties to the full-chip layout; and
executing a full-chip simulation of the semiconductor circuit by using the full-chip layout.

2. The semiconductor full-chip simulation method of claim 1, wherein the artificial intelligence model is a model trained to:
receive a first tile and a second tile of the plurality of tiles; and
associate the first tile and the second tile with a same cluster of the plurality of clusters based on a pattern shape of each of the first tile and of the second tile and based on a difference in density between the first tile and the second tile, wherein
densities of the first tile and the second tile are labeled.

3. The semiconductor full-chip simulation method of claim 2, wherein the artificial intelligence model is a model trained to associate the first tile and the second tile with the same cluster based on one or more properties with which the first tile and the second tile are labeled.

4. The semiconductor full-chip simulation method of claim 1, wherein obtaining the representative pattern for each cluster comprises determining, for each cluster, a pattern of a tile having the highest probability of belonging to the cluster as the representative pattern of the cluster.

5. The semiconductor full-chip simulation method of claim 1, wherein obtaining the representative pattern for each cluster comprises determining, for each cluster, a pattern of a tile closest to a center of the cluster as the representative pattern of the cluster.

6. The semiconductor full-chip simulation method of claim 1, wherein obtaining the representative pattern for each cluster comprises determining, for each cluster, a pattern of a tile closest to a center of the cluster and having a probability of belonging to the cluster that is greater than or equal to a preset threshold value as the representative pattern of the cluster.

7. The semiconductor full-chip simulation method of claim 1, wherein executing the full-chip simulation comprises:
arranging the plurality of representative patterns in a preset form in the full-chip layout as a mesh;
obtaining properties of the mesh based on the extracted properties; and
executing the full-chip simulation based on the properties of the mesh.

8. The semiconductor full-chip simulation method of claim 7, wherein obtaining the properties of the mesh comprises:
calculating an average of the extracted properties to provide a calculated average; and
setting extracted properties having a smallest difference from the calculated average as the properties of the mesh.

9. The semiconductor full-chip simulation method of claim 7, wherein obtaining the properties of the mesh comprises:
inputting the extracted properties to a neural network model; and
setting properties output from the neural network model as the properties of the mesh.

10. The semiconductor full-chip simulation method of claim 7, wherein arranging the plurality of representative patterns as the mesh comprises merging a first mesh and a second mesh, which are different from each other, based on each of the first mesh and the second mesh having a group of representative patterns arranged in a same form.

11. The semiconductor full-chip simulation method of claim 1, wherein the properties are related to warpage of the semiconductor circuit, and
executing the full-chip simulation comprises executing a warpage simulation of the semiconductor circuit.

12. The semiconductor full-chip simulation method of claim 1, wherein the extracted properties relate to thermal properties of the semiconductor circuit, and
executing the full-chip simulation comprises executing a thermal simulation of the semiconductor circuit.

13. A semiconductor full-chip simulation apparatus comprising:
a processor;
a memory; and
computer-executable instructions stored in the memory,
wherein when the instructions are executed by the processor, the instructions cause the processor to perform operations comprising:
dividing a full-chip layout of a semiconductor circuit into a plurality of tiles;
converting the plurality of tiles into a plurality of image tensors, wherein converting the plurality of tiles comprises preprocessing the plurality of tiles;
clustering the plurality of tiles by inputting the plurality of image tensors to an artificial intelligence model;
obtaining a representative pattern for each cluster of a plurality of clusters generated as a result of the clustering to provide a plurality of representative patterns;
substituting, within each cluster, each tile of the cluster with the representative pattern obtained for the cluster;
extracting, for each representative pattern of the plurality of representative patterns, properties corresponding to the representative pattern to provide extracted properties, wherein extracting the properties comprises using a representative volume element method;
mapping the extracted properties to the full-chip layout; and
executing a full-chip simulation of the semiconductor circuit by using the full-chip layout.

14. The semiconductor full-chip simulation apparatus of claim 13, wherein the artificial intelligence model is a model trained to:
receive a first tile and a second tile of the plurality of tiles; and
associate the first tile and the second tile with a same cluster of the plurality of clusters based on a pattern shape of each of the first tile and of the second tile and based on a difference in density between the first tile and the second tile, wherein
densities of the first tile and the second tile are labeled.

15. The semiconductor full-chip simulation apparatus of claim 13, wherein obtaining the representative pattern for each cluster comprises determining, for each cluster, a pattern of a tile having the highest probability of belonging to the cluster as the representative pattern of the cluster.

16. The semiconductor full-chip simulation apparatus of claim 13, wherein obtaining the representative pattern for each cluster comprises determining, for each cluster, a pattern of a tile closest to a center of the cluster as the representative pattern of the cluster.

17. The semiconductor full-chip simulation apparatus of claim 13, wherein obtaining the representative pattern comprises determining, for each cluster, a pattern of a tile closest to a center of the cluster and having a probability of belonging to the cluster that is greater than or equal to a preset threshold value as the representative pattern of the cluster.

18. The semiconductor full-chip simulation apparatus of claim 13, wherein executing the full-chip simulation comprises:
arranging the plurality of representative patterns in a preset form in the full-chip layout as a mesh;
obtaining properties of the mesh based on extracted properties; and
executing a full-chip simulation based on the properties of the mesh.

19. The semiconductor full-chip simulation apparatus of claim 18, wherein obtaining the properties of the mesh comprises:
calculating an average of the extracted properties to provide a calculated average; and
setting the extracted properties having a smallest difference from the calculated average as the properties of the mesh.

20. A non-transitory computer readable medium storing therein a computer program, wherein when the computer program is executed by a processor, the computer program causes the processor to perform operations comprising:
dividing a full-chip layout of a semiconductor circuit into a plurality of tiles;
converting the plurality of tiles into a plurality of image tensors, wherein converting the plurality of tiles comprises preprocessing the plurality of tiles;
clustering the plurality of tiles by inputting the plurality of image tensors to an artificial intelligence model;
obtaining a representative pattern for each cluster of a plurality of clusters generated as a result of the clustering to provide a plurality of representative patterns;
substituting, within each cluster, each tile of the cluster with the representative pattern obtained for each cluster;
extracting, for each representative pattern of the plurality of representative patterns, properties corresponding to the representative pattern to provide extracted properties, wherein extracting the properties comprises using a representative volume element method;
mapping the extracted properties to the full-chip layout; and
executing a full-chip simulation of the semiconductor circuit by using the full-chip layout.
